(19) United States
(12) Patent Application Publication
(10) Pub. No.: US 2019/0127062 A1
(43) Pub. Date: May 2, 2019

(54) Airplane without wings

(71) Applicant: Warner H. Witmer, Royersford, PA (US)

(72) Inventor: Warner H. Witmer, Royersford, PA (US)

(21) Appl. No.: 15/732,344

(22) Filed: Oct. 27, 2017

(51) Int. Cl. B64C 29/04; B64D 33/02; B64C 15/02; B64C 19/00

(52) U.S. Cl. CPC B64C 29/04; B64D 33/02; B64D 2033/0273; B64C 19/00; B64C 15/02

(57) ABSTRACT

This aircraft without wings is designed to allow unmanned flight to any place on earth by simplified construction. This is accomplished by turning the gas turbine engine upward, by means of a geodesic flight organizer, by air mass cooling, and because of its massive amount of power. The VTOL aircraft is never detained by looking for a runway. A conventional jet aircraft needs a long runway to go fast enough for takeoff speed. That's why airports are so big, because conventional jet planes sometimes have to take off at 200 miles per hour for lift. This aircraft shoots straight upwards and then the horizontal stabilizers are turned on. The small-sized box or barrel goes anywhere you want it to go. The aircraft is designed to allow unmanned flight to any place that has air, or the gas of another planet. The aircraft is guided by using a geodesic flight organizer and a gyro. The air mass is split so part goes to the combustion chamber and the other part goes to the thruster for oxygen power. This airplane goes straight up from anywhere, quickly. And the VTOL flight is not exposed to finding a runway, anywhere. The unmanned aircraft will be used to send medical equipment or emergency fire-fighting apparatus, or any other material as needed.

### 1. BACKGROUND OF THE INVENTION

This aircraft is designed to eliminate wings on an aircraft to create a VTOL aircraft like a helicopter but without the overhead propeller. The field of the invention concerns a new aircraft without wings. The U.S. patent classification is 244. References to specific problems I haven't been able to find any prior art.

The gas turbine engine is a type of air breathing jet engine that is widely used in aircraft propulsion. This is because the gas turbine engine combines all the power phases used in automobile engines in one continuous ignition. An automobile uses the power phases of collection, compression, explosion, and the waste exhaust exit. The explosion apparatus is like a ‘balloon’ with an ideal gas under high pressure and high temperature. Most of the contemptuous apparatus associated with the ‘balloon’ is designed to function as a means to cool the outside of the ‘balloon’ and to supply oxygen for fueling the explosion. This is a very high temperature ‘balloon’. In addition to the functions of a ‘balloon’ it must be able to create a huge controlled explosion. The combustion chamber must be very strong to resist the very high pressure and it must be high temperature resistant, and it must have access to continual fuel. In addition it must have a way of capping the horizontal pipes to have the aircraft get to the proper places. In this way accomplishing controlled maneuverability in the horizontal direction must be achieved. For an aircraft to provide these things without wings yet still carry on becomes almost impossible. It needs access to provide fuel for the explosion and air mass to be able to provide an air mass generator without using a dangerous fan. It must continually provide a controlled explosion. For horizontal positioning it requires all these things and they must be variable.

An ideal gas is one that follows the ideal gas laws. The equation is PV=nRT, where P is the pressure, V is the volume, T is the temperature, and n is the number of moles of gas. (1 mole of gas has 6×10²³ particles), or Avogadro's number, and R is called the gas constant. The French physicist Emil Chaperon in the 19^{th} century, tells how the pressure, temperature, and volume are all related. Pressure increases if the volume is squeezed or the temperature is raised. Imagine a box with air inside. If you reduced the volume of the box by half, then the pressure would be doubled. If you heated the metal box to twice its temperature then its pressure would also double. In deriving the ideal gas law, Chaperon combined two earlier laws one by Robert Boyle and another by Jacques Charles and Joseph Louis Gay-Lussac. Boyle had spotted links between pressure and volume, and Charles and Gay-Lussac between volume and temperature. Chaperon united the three quantities by thinking about a quantity of gas called a ‘mole’, a term describing a certain number of atoms or molecules, namely 6×10²³ (6 followed by 23 zeroes) known as Avogadro's number. Although this sounds like a lot of atoms, it is roughly the number of atoms you would find in a graphite pencil. The mole is defined as the number of carbon-12 atoms in 12 grams of carbon. Alternatively, if you had Avogadro's number in grapefruits, they would take up to the entire volume of the Earth.

So an ideal gas is one that obeys the ideal gas laws. It does this because the atoms or molecules that make it up are very small compared with the distances between them so that when they bounce around they scatter off one another. Also, there are no extra forces between particles that could cause them to stick together, such as electrical charges. Nobile gases such as neon and xenon behave as ideal gases made up of individual atoms, rather than molecules. Symmetric light molecules like hydrogen, nitrogen, or oxygen behave almost like ideal gases, whereas heaver gas molecules such as butane are less likely to. The air issuing from this ‘balloon’ must issue so that the forces counter the controlled force at selected places for horizontal movement.

Most of the components of a gas turbine engine are to add compression to the air flow. That is what the huge fan does for a conventional jet passenger aircraft. A much better method is shown.

### 2 BRIEF SUMMARY OF THE INVENTION

This Aircraft Without Wings eliminates the huge fan in the conventional aircraft and this allows a much smaller VOTL aircraft. By turning the gas turbine engine upward with the thrust downward the aircraft accomplishes VTOL flight and geodesic equipment controls the aircraft and is horizontally guided by the controllable tubes. In addition the new design eliminates the huge fans and allows a much better air mass separation. All of these things had to be available for the Aircraft Without Wings.

The VOTL aircraft is the first with to turn its gas turbine engine to point skyward and the thruster to point downward. The air mass is accurately accomplished by splitting it. One part continues through to the ‘core’, or the center of the engine, where it acts upon the engine components and the second part ‘bypasses’ the core of the engine and goes through a second pipe concentric with the first. The first air mass goes to the core of the engine and causes increased thrust. The second air mass is concentric with the first and of a much larger diameter. It produces thrust because it contains huge amounts of oxygen and ignites when it passes the thruster, under pressure. The cooler air from the larger air mass collector helps to quiet the engine as well as adding thrust to the engine. The action of this air mass adds 70% to the speed. The apparatus is also applicable to the conventional orientation of the gas turbine engine. The air mass apparatus can get air mass to a jet plane without the four huge fans. This is accomplished by removing the huge fans and controlling the air mass by using two parts of air separately.

### 3. BRIEF DESCRIPTION OF THE DRAWINGS

FIG. 1. The combustion chamber is shown in FIG. 1 with the pipes around it for outside control of the horizontal geodesic location.

FIG. 2. Shows a side view of the combustion chamber showing the top and bottom surfaces of 1 with numerous holes for air mass and fuel at the top. The thruster is shown at the bottom. The tubes are for horizontal movement after achieving height.

FIG. 3. This drawing shows VTOL flight by turning the entire device upright and the thruster facing downward. This type mechanism is applicable to replacement of the huge fans in a conventional aircraft. It shows the box or barrel shaped holder of the gas turbine engine. This reduces aircraft size tremendously because there are no wings. The pipes used for horizontal flight are supported by the air mass apparatus and the outer walls of the cabin 15. The horizontal tubes in the FIG. 3 hold the combustion chamber in place and the air mass apparatus at the top of the combustion chamber supplies air mass for the inside of the combustion chamber. The larger pipe concentric with the first supplies the air mass to the outside of the combustion chamber igniter and enhances thruster efficiency.

FIG. 4 shows the moveable cap on the tube for providing the geodesic location. The bands are electrically stimulated as attached to the geodesic indicator.

FIG. 5 shows more details of the caps where three tubes having covers are controlled by means of the horizontal geodesic device.

FIG. 6 shows the direction and density of controlled air by the air mass device. The arrows represent the direction and the density of the air mass. This eliminates the huge fan problem.

FIG. 7 shows a more elaborate method of horizontal movement. It is designed to control the direction and variable speed of the gas through the tubes affecting movement in any horizontal direction. The drawing shows an auxiliary tank on the left side (in the drawing only, used for illustration). This stores the hot gas pressure directly from the combustion chamber to the separate tank for each pipe. This is done to control the pressure of the gas from the combustion chamber to the tube. A metal flat board variably controls the pressure in the tank by geodesic electronic control (not shown).

On the right side of the drawing is the apparatus controlling the amount of air mass to provide power to the horizontal tubes. Air loaded with oxygen is configured to encircle the pipe to provide thrust that supplies 70% of the movement when ignited by the outgoing tube. The metal board sliding up/down to control the amount of air released to the tubes is activated by geodesic electronic control (not shown).

By combining the illustration on left side with the illustration on the right side we see how to combine them for each horizontal tube.

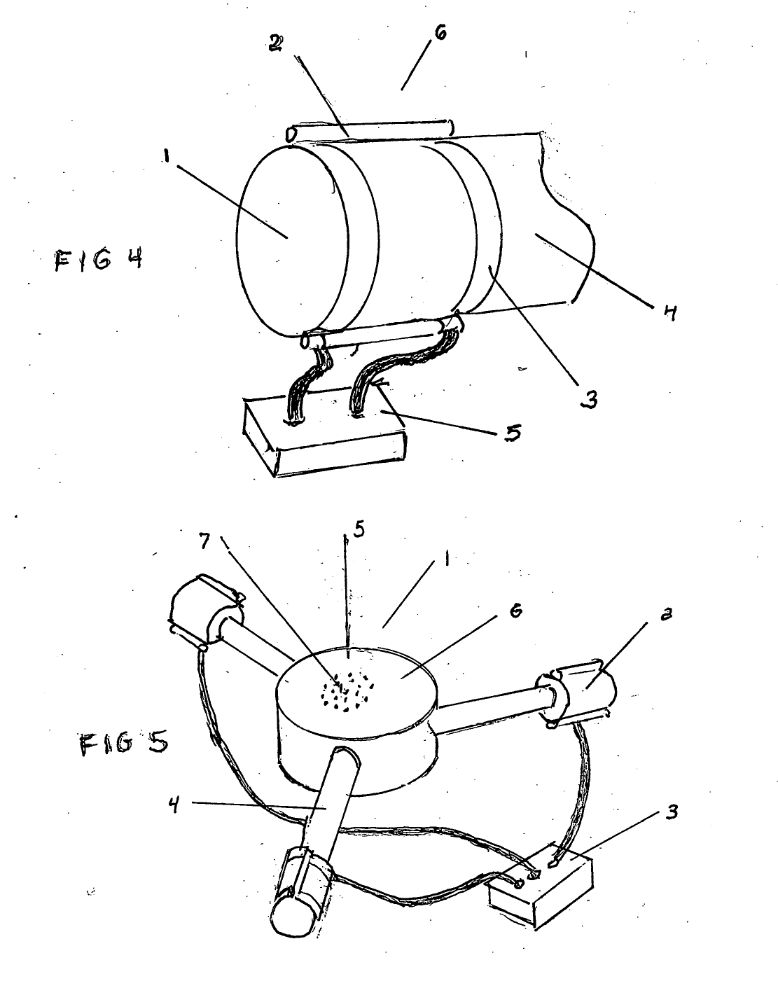

### FIG. 4. DETAILED DESCRIPTION OF THE DRAWING

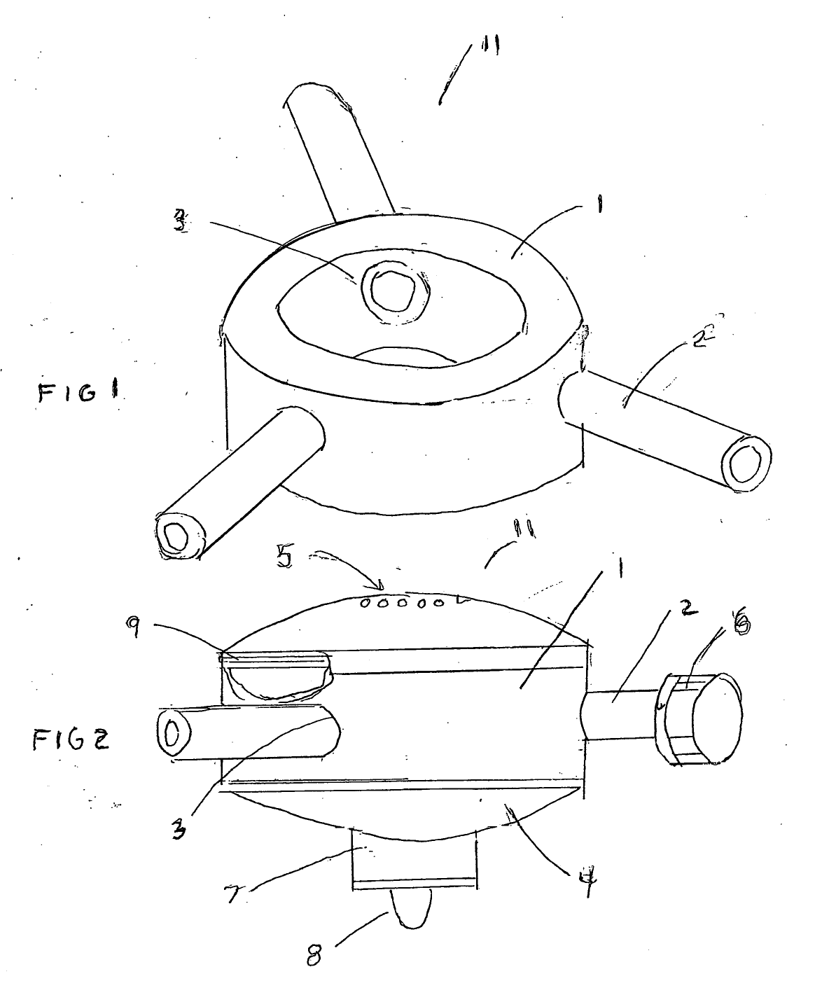

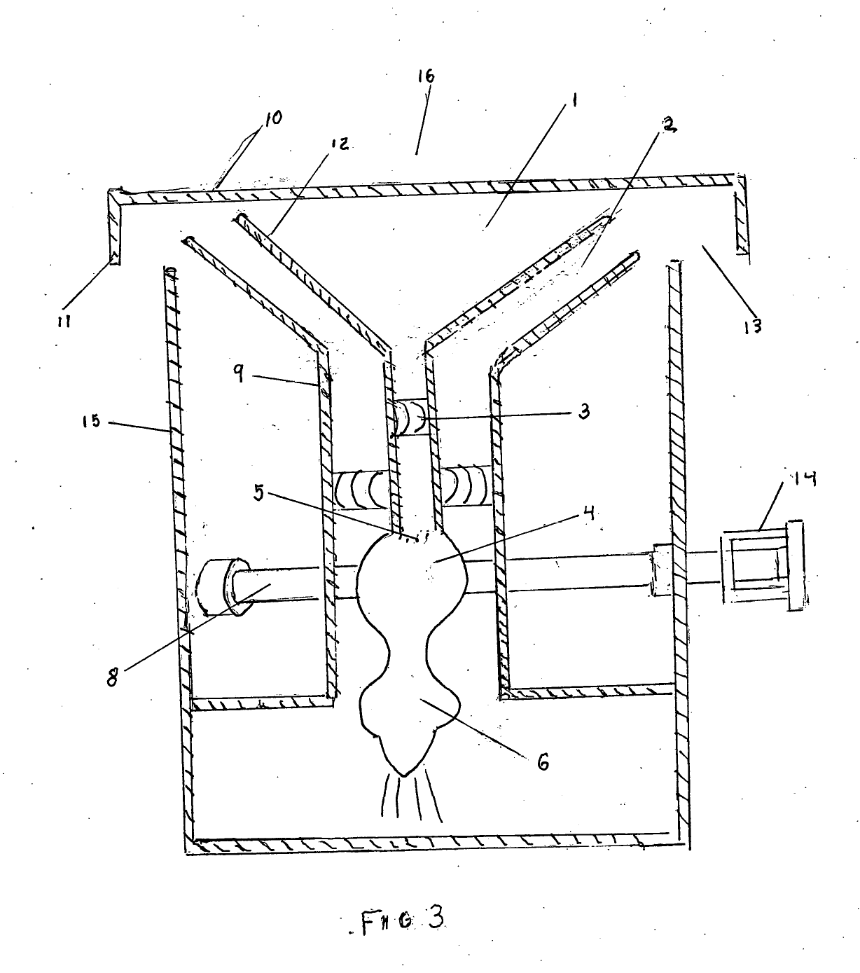

The right options to manufacture the device, making it the first aircraft which does not have wings and is supported entirely by the gas turbine engine in flight. FIG. 1 shows 11 the details of the Airplane Without Wings. The first thing to do is design the ‘balloon’ 1 to hold the other apparatus and allow the continuous explosion. FIG. 1 also shows the combustion controller 11 in an oblong shape with three pipes 2 separated from each other by one hundred twenty degrees, for horizontal flight. The material they are made from is generally a material like ceramic or high temperature metals like Nimoic, or Inconel, or other high temperature materials. The horizontal tubes 2 are constructed with the same material as 1. These smaller tubes 2 are attached by screwing 3 them into the combustion chamber body 1. There can be three or four pipes or more, such that they represent East, West, North, and South but they must always be capable of moving at the instruction of the geographical control system.

FIG. 3. This figure shows the first component of the conventional engine ‘core’ to be eliminated. It is the compressor which is made of a fan with many blades attached to a shaft. The compressor squeezes the air to make it of progressively smaller volume. It is not used in the invention because it wastes power.

The air mass 1 is continually mixed with fuel at 5, and the combustion chamber continually ignites it. There are as many as twenty nozzles 5 which spray fuel into the combustion chamber airstream. The mixture of air and fuel catches fire in the combustion chamber 4 and this provides a high temperature, high-energy airflow. The fuel burns because copious oxygen is supplied by air mass collector 1. The compressed air is further compressed in the three tubes marked by identity 8 because of the expanding gases inside of the combustion chamber 4. The combustion chamber is often made of ceramic materials because it gets so hot. This material provides heat resistance for the chamber where the heat can reach 2700° F. The high-energy gas flow coming out of the chamber is used in conventional jet planes to turn the shaft on the compressor (not shown). Because the air mass apparatus is designed to supply a large quantity of air we will not use it because it is an energy user and we will skip the compressor. The power to run the shaft and spin the compressor takes energy so we will drop it. Also the gasses produced in the combustion chamber 4 is sometimes used to spins a turbine, but this too is an added draw on the power. So it will be dropped. The combustion chamber shaft that moves the huge fans at the front of the conventional jet aircraft is also dropped because of the drag of these fans.

The thruster 6 provides the thrust to propel the aircraft up/down. The thrust nozzle 7 directs the flow of thrust and provides minor guidance to the aircraft. The expansion of air produced by the combustion of huge amounts of incoming oxygen to the thruster provides 70% of the forward thrust speed.

FIG. 4 shows the horizontal tubing 4, and the cap 1. Electrical power to each cap and the geodesic guidance system opens and closes the cap 1. The bar 2 is expandable by the geodesic system which opens the cap 1 of a tube letting out the hot air according to the control device on the three tubes.

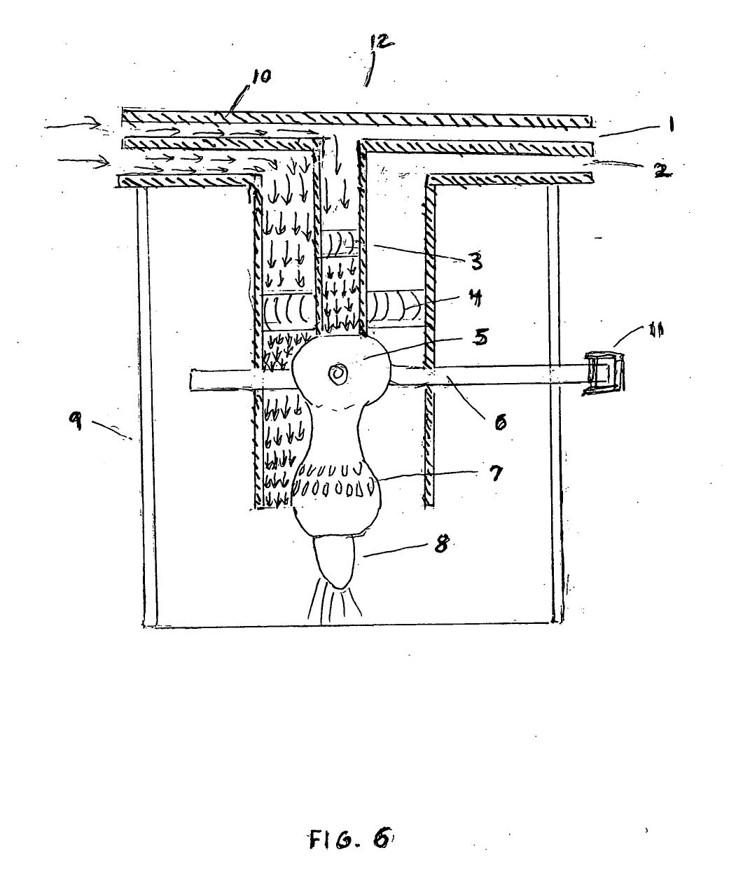

FIG. 5. If one controller pipe lets pressure move the cap the aircraft will move in an opposite direction. If appropriate control of all of the pressurized tubes is controlled by the geodesic instrument the movement will be the sum of the geodesic instrument moving accurately. This shows the complete power system controlling pressure in the tubes. The combustion chamber provides pressure to the tubes 4. Each tube 4 has a cap 2 that is actuated by electrical wires 8 and attached to the geodesic 3 controller or geometric location system. The geodesic device opens or closes the cap as directed to control the pressure in the tube. Each cap, or nozzle, is controlled independently then vectored for geodesic guidance. By control of the pressure in the tubes the positioning control in each tube is attained. By this mechanism and the use of the Geometrical Control System geodesic guidance is provided. The control of the horizontal tubes is by the pressure control of the caps by the geodesic program.

FIG. 6 shows the speed and density of the air masses before reaching the combustion chamber. Only the left side is displayed. The first air mass device is collecting air at 1 for attaining the huge mass of air to the holes at the top of the combustion chamber 5 where the oxygen is designed to ignite the gas in 5, showing a huge pressure increase. The second air mass device shows that the mass production of air 2 is greater by the diameter of the air collector 1. By the air mass collected by 2 the outside of the combustor chamber 5, the thruster 7, and the thruster nozzle 8 are kept cool. Plus when the compressed air in the duct 2 reaches the outside of the thruster 7 the temperature ignites it by supplying a copious supply of oxygen to 7 providing power sufficient to increase the forward speed by 70%. If more pressure is needed impellers 3 and 4 may be used. If the pressure from 5 is too strong a secondary ‘balloon’ is used. When the igniter-combustor 5 becomes pressurized and the horizontal tubes 8 are controlled by electrical caps 11 the pressure in the tubes is ideal. A turbine creating electricity for the geographic control system is not shown. The outside cabin 9 creates protection for the apparatus.

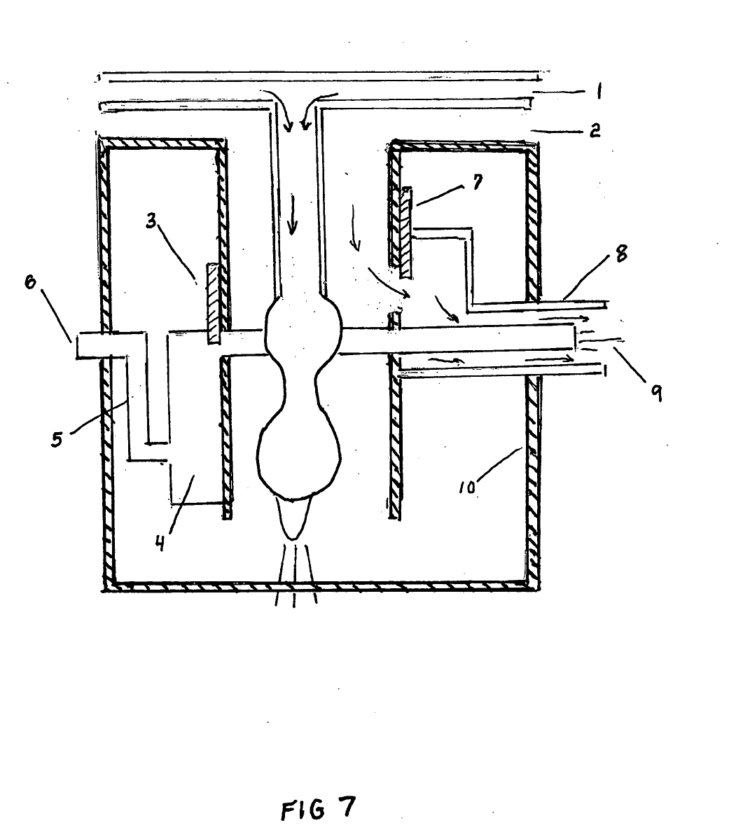

FIG. 7 shows a more complicated apparatus in overview. This sketch shows on the left side how the gas pressure can be regulated. And on the right side it shows how by having a concentric air tube an increase of 70% of the speed of the thrust from the tube becomes possible. The left side is used first and the right side is used second for each tube. There is the room to combine the two.

The oxygen containing air is split into two parts, the same as in FIG. 6. It is air flow 2 that we are concerned with. The Up/Down ‘window’ 3 (shaded) is activated by the geodesic apparatus (not shown). By the metal door 3 the geodesic controls the amount of pressure to tank 4. Then the gas is delivered from tube 5 and the pressure 6 is attained. The pressurized gas at 6 is controlled by this apparatus.

On the right side the same air mass 2 is used to cause oxygen in the air to get to the concentric pipe 8 around the tube. The volume of air is controlled by the Up/Down ‘window’ 7 (shaded) and is activated by the geodesic electronics device (not shown). The metal door controls the volume of air in the pipe 8 that is concentric to the tube. The additional thrust is shown by 9. A gyro must be available to stabilize the plane.

### 5. AFTERWARD

This aircraft is designed to allow unmanned flight to any place on earth by simplified construction. This is accomplished by turning the gas turbine engine upward, a simple geodesic flight organizer, air mass cooling, and the massive amount of incoming oxygen for power. By this VTOL flight the aircraft is not exposed to finding a runway, anywhere. The conventional jet aircraft needs a long runway to go fast enough and to reach takeoff speed. A jet transport must travel 200 miles an hour before the lift is strong enough to raise the huge passenger aircraft. This airplane goes straight up from anywhere, quickly. It is only a pilotless small-sized box or barrel that goes anywhere you want it to go. A gyro keeps it balanced.

The unmanned aircraft could send medical equipment where needed. Also, fire-fighting equipment could be sent quickly. Anywhere a package delivery is required the box can deliver it. In addition lift is created by air rushing down the funnel-shaped surface allowing added lift because of the Bernoulli Principle and the Coanda Effect. The roof of the air mass controllers 10 provides protection from ice and snow. The impellor controllers 3, and 4 create further density if needed for the air mass generators. The initial air mass at startup is drawn by the vacuum created by the combustion chamber.

The claimed invention is the first aircraft flying on engine power and not on wings or propellers.

1. An aircraft designed with the gas turbine engine pointing upward for direct takeoff and landing;
a) and consisting of air mass apparatus supplying lift;
b) and the air mass supplying separate oxygen for the combustion chamber and oxygen for thrust;
c) and air mass sent to the igniter, with cool external air to the combustion chamber, and air mass supplying thrust;
d) and combustion chamber with ring shaped body having tubes which supply horizontal movement of the aircraft travel when screwed into the ring of igniter;
e) and a fuel as a spray for powering the igniter, and horizontal thrusters for up-down positioning;
f) and a turbine rotating fast to create electricity to a battery, for controlling the geographical control system.

2. As recited in claim 1, the lifting apparatus capable of supplying fast moving air mass as gathered at the periphery, and speeding down the interior of the funnels to create the Coanda Effect and Bernoulli Principle and creating added lift.

3. As recited in claim 1, the fast moving air mass propelled by the impellors, are forced downward, supplying oxygen to the igniter and for continually burning the fuel;

4. As recited in claim 1, the top of the igniter contains a fuel spray consisting of fuel nozzles and the air mass for continually supplying oxygen, with the fuel easily ignited.

5. As recited in claim 1, a second larger air mass source is generated for cooling the outside of the igniter and for supplying oxygen to the main thruster.

6. As recited in claim 1, the igniter body is a circular ring into which the horizontal thrust pipes are screwed into the pipes, from the ring-shaped body, allowing horizontal travel, and having ends that are capped variably as required by the electronic geodesic programing.

7. As recited in claim 1, a small turbine, speeding round to create electricity stored by batteries, the electricity powering the electronic geodesic program.
